(19) United States
(12) Patent Application Publication
(10) Pub. No.: US 2017/0345030 A1
(43) Pub. Date: Nov. 30, 2017

(54) FLASH RETAILING

(71) Applicant: b8ta, Inc., San Francisco, CA (US)

(72) Inventors: Vibhu Norby, Mountain View, CA (US); William Mintun, Aptos, CA (US); Phillip Raub, San Francisco, CA (US); Nicholas Mann, San Jose, CA (US)

(73) Assignee: b8ta, Inc., San Francisco, CA (US)

(21) Appl. No.: 15/609,565

(22) Filed: May 31, 2017

Related U.S. Application Data
(60) Provisional application No. 62/343,805, filed on May 31, 2016.

(51) Int. Cl. G06Q 30/02; G06Q 30/06; G06Q 10/06

(52) U.S. Cl. CPC G06Q 30/0201; G06Q 30/0645; G06Q 10/067

(57) ABSTRACT

Techniques for selling products through flash retailing. A system utilizing such techniques can include a facility, a retailer system, a product developer system, and a flash retailing management system. A method utilizing such techniques can include facility management, product developer management, and retailer system management.

### CROSS-REFERENCE TO RELATED APPLICATIONS

This application claims priority to U.S. Provisional Patent Application Ser. No. 62/343,805, filed May 31, 2016, which is incorporated by reference herein.

### BRIEF DESCRIPTION OF THE DRAWINGS

FIG. 1 depicts a diagram of an example of a system for managing flash retailing for purposes of selling merchandise.

FIG. 2 depicts a diagram of an example of a flash retailing management system.

FIG. 3 depicts a diagram of an example of a system for securing a right to use a facility for flash retailing.

FIG. 4 depicts a diagram of an example of a system for configuring a facility for flash retailing according to a product developer.

FIG. 5 depicts a diagram of an example of a system for maintaining product analytics data for products flash retailed at a facility.

FIG. 6 depicts a flowchart of an example of a method of securing a right to occupy a facility for a product developer for purposes of offering their products through flash retailing.

FIG. 7 depicts a flowchart of an example of a method for configuring a facility for offering a product through flash retailing.

FIG. 8 depicts a flowchart of an example of a method for maintaining data used in managing flash retailing of a product.

### DETAILED DESCRIPTION

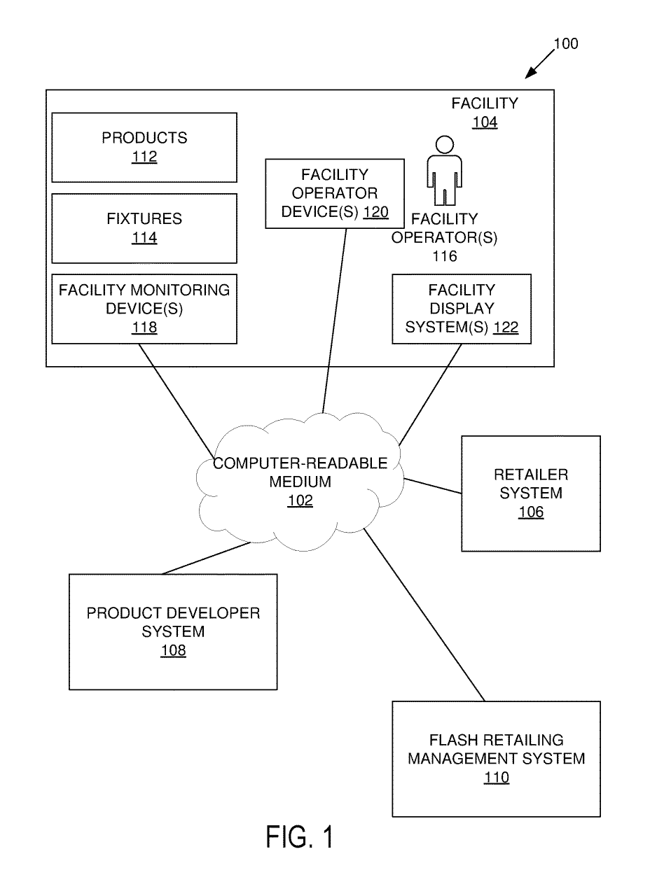

FIG. 1 depicts a diagram 100 of an example of a system for managing flash retailing for purposes of selling merchandise. The system of the example of FIG. 1 includes a computer-readable medium 102, a facility 104, a retailer system 106, a product developer system 108, and a flash retailing management system 110. In the example system shown in FIG. 1, the retailer system 106, the product developer system 108, and the flash retailing management system 110 are coupled to each other through the computer-readable medium 102.

The computer-readable medium 102 and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102 and other applicable systems or devices described in this paper can be implemented as a computer system or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors, at least partially implemented in hardware, or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Flash retailing, otherwise referred to as selling a product according to a flash retailing model, includes renting space or securing a right to sell at a facility, a physical location, for purposes of selling products on a temporary or rented basis. Flash retailing also includes aspects of subsequent selling of a product through the facility. In various implementations, flash retailing includes renting space at a facility by a product developer who is independent from the facility. For example, flash retailing can include different product developers renting space at a facility to sell their products. Further in the example, flash retailing can include different product developers renting space at a retail facility location for, at least a temporary basis, for selling the different products autonomously from each other while still occupying, at least in part, the same retail facility location. In various implementations, a product developer can provide a share of profits of selling merchandise as part of rent for space at a facility for purposes of selling the merchandise. Through the use of flash retailing, a manufacturer can secure space at a physical retail location to sell their product without having to invest overhead in renting and setting up an entire retail location by themselves. In various implementations, flash retailing can be used to determine whether a product is successful before beginning manufacture of the product on a mass scale.

In a specific implementation, flash retailing includes reserving a right to sell a product through a retailer system and the subsequent selling of the product through the retailer system. For example, flash retailing can include a product developer independent of a retailer system reserving the right to sell a product through a retailer system and the actual sale of the product through the retailer system. In various implementations, flash retailing includes reserving the right to sell a product through an online store of a retailer system and the actual selling of the product through the online store.

The facility 104 functions as a space for providing flash retailing for merchants. Depending upon implementation-specific or other considerations, the facility 104 is provided by an applicable entity for managing flash retailing space rental at the facility 104. For example, the facility 104 can be store space owned or rented, otherwise provided, by an entity managing rental of portions of the store space for flash retailing. Further depending upon implementation-specific or other considerations, the facility 104 can be provided by a retail store of an entity that sells its own products and also provides flash retailing services. For example, the facility 104 can be provided by a chain of consumer electronic stores that also provides flash retailing services to individual product developers. Further in the example, in using a retail store to provide flash retailing services, a need to invest in infrastructure for setting up and maintaining a retail store is eliminated from either or both the individual product developers and an applicable entity for managing flash retailing space rental at the facility 104, e.g. a third party entity separate from the retailer.

The retailer system 106 functions to manage sale of products by a retailer. Depending upon implementation-specific or other considerations, the retailer system 106 can be used to manage sale of a retailers own products. For example, if a retailer is a consumer electronics store, then the retailer system 106 can be used in managing sales its own consumer electronics products. Further depending upon implementation-specific or other considerations, the retailer system 106 can be used to managing sale of products sold by a retailer as part of flash retailing services provided by the retailer. For example, if a product developer has secured space at a retail location of a retailer for selling a product as part of flash retailing, then the retailer system 106 can be used to manage sale of the product by the retailer at a retailer's facility. In various implementations, the retailer system 106 can be implemented, in part as part of an online store of a retailer. Further in the various implementations, the online store can be used to advertise a product sold by a retailer as part of flash retailing. For example, the retailer system 106 can be utilized to sell a product developer's product, as part of flash retailing, in an online store of a retailer to a customer. Further in the example, the customer, after purchasing the product, can either have the product shipped to them, using retailer system 106, or elect to pick up the product at a retail location, e.g. facility, of the retailer. Still further in the example, the customer can use the retailer system 106 to return the product.

In a specific implementation, the retailer system 106 is specific to an entity that manages flash retailing. Depending upon implementation-specific or other considerations, an entity that manages flash retailing can setup and maintain its own retailer system for purposes of selling products offered as part of flash retailing. For example, an entity managing flash retailing can maintain its own retailer system and secure its own facility for purposes of selling products as part of flash retailing.

In a specific implementation, the retailer system 106 functions to be configured for use in selling a product through flash retailing. In various implementations, a retailer's online store supported by the retailer system 106 can be configured as part of configuring the retailer system 106. For example, a retailer's online store can be modified to include a description of a product offered through flash retailing. In another example, a retailer's online store can be modified to include customer reviews of a product offered as part of flash retailing. Depending upon implementation-specific or other considerations, the retailer system 106 can be configured according to retailer configuration input received from a product developer of a product offered through flash retailing. For example, a product developer can provide retailer configuration input indicating to offer two products together, and a retailer's online store supported by the retailer system 106 can be configured to offer the two products together according to the input. Further depending upon implementation-specific or other considerations, the retailer system 106 can be configured according to retailer configuration input received from a system for managing flash retailing, such as the flash retailing management systems described in this paper.

In a specific implementation, the retailer system 106 provides functionalities to a potential customer for viewing a demonstration of a product offered as part of flash retailing. In providing functionalities to a potential customer to view a demonstration of a product, the retailer system 106 can provide a web interface to the potential customer for demonstrating a product offered through flash retailing. For example, code of a website of a retailer can be modified or code can be injected into the website to cause the website to include a portal to provide functionalities to consumers for demonstrating a product. Depending upon implementation-specific or other considerations, the retailer system 106 can provide a web-based reservation portal to potential customers, through which the potential customers can reserve times and/or locations to view demonstrations of products offered as part of flash retailing. Further depending upon implementation-specific or other considerations, the retailer system 106 functions to manage demonstrations of a product offered through flash retailing. For example, the retailer system 106 can inform a potential customer available appointments to view a demonstration of a product and subsequently book an appointment for the potential customer. Further in the example, the retailer system 106 can present an option to the potential customer to purchase the product, and facilitate purchase of the product, along with presenting the available appointment times to demonstrate the product.

The product developer system 108 functions to provide functionalities to a product developer in managing flash retailing of their products. Depending upon implementation-specific or other considerations, the product developer system 108 can be used to secure or rent space at a facility for use in flash retailing a product developer's products. For example, the product developer system 108 can be used to purchase a right to sell products at a facility as part of flash retailing. Further depending upon implementation-specific or other considerations, the product developer system 108 can be used to provide retailer configuration input. For example, the product developer system 108 can be used by a product developer to input specification of a product for advertising the product through an applicable system, such as the retailer systems described in this paper. Depending upon implementation-specific or other considerations, the product developer system 108 can be implemented, at least in part, as a web-based application or a native application executing on a device of a product developer.

In a specific implementation, the product developer system 108 functions to provide functionalities to a product developer for use in managing a facility at which a product of the product developer is offered as part of flash retailing. Depending upon implementation-specific or other considerations, the product developer system 108 can be used by a product developer to provide facility configuration input. Facility configuration input includes applicable data regarding how to configure or operate a facility for purposes of selling a product included sold through flash retailing. For example, facility configuration input can include data describing how to present a product at a facility. In another example, facility configuration input can include product information indicating how to demonstrate a product sold as part of flash retailing. Further in the another example, facility configuration input can be used to instruct sales representatives how to sell the product at a facility as part of flash retailing.

The flash retailing management system 110 functions to manage flash retailing of products for a product developer. In various implementations, the flash retailing management system 110 can secure facility space for a product as part of flash retailing. For example, the flash retailing management system 110 can reserve for a product a right to be presented at a facility for purposes of selling the product. In another example, the flash retailing management system 110 can reserve for a product a right to have the product demonstrated at a facility for purposes of selling the product. Depending upon implementation-specific or other considerations, the flash retailing management system 110 can present potential facilities for flash retailing to a product to a product developer. For example, the flash retailing management system 110 can show a product developer that space is available at three facilities, e.g. physical retail locations, within a city and the length of time the space is available which can then be used by the product developer to obtain the right to occupy the space.

In a specific implementations, the flash retailing management system 110 functions to present to a product developer price structures for flash retailing a product at a facility. Presented price structures can be used by a product developer to select a price structure for securing rights to flash retail the product at the facility according to a chosen price structure. A price structure can include a price for obtaining a right to flash retail a product at a facility. For example, a price structure can specify that an entity for managing flash retailing and/or a retailer receives a percentage of sales of a product flash retailed at a facility. In another example, a price structure can specify a flat fee an entity for managing flash retailing and/or a retailer receives as a result of flash retailing a product. In various implementations, the flash retailing management system 110 can obtain a right to flash retail a product according to a chosen price structure.

In a specific implementation, the flash retailing management system 110 functions to configure an applicable retailer system, such as the retailer systems described in this paper, for purposes of flash retailing. Depending upon implementation-specific or other considerations, the flash retailing management system 110 can configure a retailer system maintained/created for itself, or for a retail entity separate from the flash retailing management system 110. For example, the flash retailing management system 110 can configure a retailer system of a consumer electronics retail chain to advertise a product for purposes of flash retailing. In another example, the flash retailing management system 110 can configure a retailer system created and maintained for itself to advertise a product for purposes of flash retailing. In various implementations, the flash retailing management system 110 can configure a retailer system according to retailer configuration input. For example, if retailer configuration input indicates to offer two products together as part of flash retailing, then the flash retailing management system 110 can configure a retailer system to offer the two products as a bundle.

In a specific implementation the flash retailing management system 110 functions to configure a facility for purposes of flash retailing. Depending upon implementation-specific or other considerations, in configuring a facility for purposes of flash retailing, the flash retailing management system 110 can cause advertisements of products to be displayed at a facility. For example, the flash retailing management system 110 can cause an advertisement received from a product developer as part of facility configuration input to be displayed at a facility. Further depending upon implementation-specific or other considerations, in configuring a facility for purposes of flash retailing, the flash retailing management system 110 can instruct facility operators to arrange products and/or fixtures within the facility through configuration instructions. For example, if facility configuration input indicates that a product should be displayed at the front of a facility, then the flash retailing management system 110 can instruct facility operators to display the product at the front of the facility. Facility configuration input can be received from a product developer by the flash retailing management system 110 in response to presentation of pre-defined facility configurations to the product developer.

In a specific implementation, the flash retailing management system 110 functions to inform facility operators of product information regarding a product being flash retailed. Product information of a product can include applicable information about a product for use in selling the product. For example, product information can include specifications of a product, functioning of a product, uses of a product, and how to demonstrate a product. Depending upon implementation-specific or other considerations, product information given to facility operators by the flash retailing management system 110 can be generated from a product developer. For example, a product developer can provide product information indicating how to demonstrate a product for flash retailing.

In a specific implementation, the flash retailing management system 110 functions to maintain consumer profiles for consumers. Consumer profiles can be maintained for consumers who interact with a facility where flash retailing products are offered or interact with a retailer system used in selling products through flash retailing. Consumer profiles include applicable information related to consumer behaviors in purchasing of products through flash retailing. For example, consumer profiles can indicate products for which a consumer has view demonstrations, products a consumer views, products a consumer purchases, and products a consumer returns. Consumer profiles can include values for consumers of market segmentation variables. Market segmentation variables include applicable demographic, geographic, psychographic, and behavioristic variables for segmenting people into markets. For example, values of market segmentation variables can include an age and sex of a consumer. In another example, values of market segmentation variables can include how a consumer behaved when at a facility selling products through flash retailing, e.g. what products a consumer had demonstrated to them. Depending upon implementation-specific or other considerations, values of markets segmentation variables can be determined based on consumer interactions with a retailer system for selling products through flash retailing. For example, if a consumer looked at specific products through an online store provided through a retailer system, then a consumer profile can be updated to reflect that the user looked at the specific products.

In a specific implementation, the flash retailing management system 110 functions to maintain consumer profiles based on data received from equipment onsite at a facility providing products through flash retailing. Depending upon implementation-specific or other considerations, the flash retailing management system 110 can maintain a consumer profile based on data received from a check-in station, e.g. a check-in kiosk. For example, if a consumer checks-in for a demonstration of a product, then the flash retailing management system 110 can update the consumer profile to indicate the consumer had the product demonstrated to them. Further depending upon implementation-specific or other considerations, the flash retailing management system 110 can maintain consumer profiles based on data received from facility monitoring devices. For example, the flash retailing management system 110 can update a consumer profile to indicate how a user behaved in a facility based on feeds from cameras within the facility.

In a specific implementation, the flash retailing management system 110 functions to maintain facility traffic data. Facility traffic data includes applicable data related to traffic through a facility. For example, facility traffic data can include movements of consumers in a facility for selling products through flash retailing, advertisements displayed, products displayed, locations in a facility where products are displayed, and products that were demonstrated. In one example, facility traffic data can include how consumers moved around a facility in response to a specific advertisement being displayed at a facility. Depending upon implementation-specific or other considerations, the flash retailing management system 110 can maintain facility traffic data using data received from equipment onsite at a facility providing products through flash retailing. For example, the flash retailing management system 110 can log consumer traffic through a facility based on feeds from cameras in the facility. In another example, the flash retailing management system 110 can log traffic data indicating a specific product was demonstrated 10 times in an hour based on data received from a facility operator device.

In a specific implementation, the flash retailing management system 110 maintains product analytics data for products sold through flash retailing. Product analytics data can include applicable data related to sales of products as part of flash retailing. For example, product analytics data can include products to be offered together to increase sales of the products. In various implementations, product analytics data can include product sales models for selling products. For example, product analytics data can include advertisements to use in selling a specific product, or products of a specific type. Product analytics data can be specific for each product offered through flash retailing. For example, product analytics data can include how many times a specific product was demonstrated, how many times a consumer interacted with a specific product, how many times a specific product was sold, and how many times a product was returned.

In a specific implementation, the flash retailing management system 110 maintains product analytics data using facility traffic data. Depending upon implementation-specific or other considerations, the flash retailing management system 110 can maintain product sales models using facility traffic data. For example, if facility traffic data indicates a specific type of product receives more foot traffic, e.g. more consumers viewing it, when it is placed at the front of a facility, then the flash retailing management system 110 can update a product sales model for the specific type of product to indicate that products of the specific type should be placed at the front of a facility. Further depending upon implementation-specific or other considerations, the flash retailing management system 110 can maintain product analytics data for a specific product using facility traffic data. For example, if facility traffic data indicates a specific product receives 100 views an hour, then the flash retailing management system 110 can update product analytics data for the specific product to indicate that the specific product received 100 views an hour.

In a specific implementation, the flash retailing management system 110 can configure a facility according to, at least in part, product analytics data. In various implementations, in configuring a facility, the flash retailing management system 110 can instruct facility operators, e.g. through facility operator devices, how to configure the facility for selling product through flash retailing. For example, the flash retailing management system 110 can instruct facility operators to place products at specific locations according to product analytics data. Further in the example, the flash retailing management system 110 can instruct facility operators to place the products at the specific locations because product analytics data indicates that at the specific locations the products will receive the most foot traffic from customers. In another example, if a product developer specifies that they want one thousand people to view their product, then the flash retailing management system 110 can configure the facility according to product analytics data to realize one thousand views of the product.

In a specific implementation, the flash retailing management system 110 functions to use facial recognition in the management of product sales through flash retailing. The flash retailing management system 110 can use facial recognition on images obtained from onsite equipment, e.g. cameras, at a facility selling products through flash retailing. Depending upon implementation-specific or other considerations, the flash retailing management system 110 can use facial recognition to maintain product analytics data. For example, if, using facial recognition, the flash retailing management system 110 determines a customer disapproves of a product, then the flash retailing management system 110 can update product analytics data for the product to indicate the customer's disapproval.

In the example system shown in FIG. 1, the facility 104 includes products 112, fixtures 114, facility operators 116, facility monitoring devices 118, facility operator devices 120, and facility display systems 122. Further, in the example system shown in FIG. 1, the facility monitoring devices 118, the facility operator devices 120, the facility display systems 122, the retailer system 106, the product developer system 108, and the flash retailing management system 110 are coupled to each other through the computer-readable medium 102. The products 112 are products sold as part of flash retailing. The products 112 can be presented to allow a consumer to interact with them or can be demonstrated for consumers. Locations of products 112 within the facility 104 can form, at least in part, a configuration of the facility 104. Depending upon implementation-specific or other considerations, a user can schedule a demonstration of products 112. For example, a user can check-in at a check-in station to schedule a demonstration of the products 112. The products 112 can be positioned within the facility 104 according to configuration instructions received from an applicable system for managing flash retailing, such as the flash retailing management systems described in this paper.

The fixtures 114 include decorations, furniture, and applicable items used for presenting the products 112. The fixtures 114 and locations of the fixtures 114 within the facility can form, at least in part, a configuration of the facility 104. Depending upon implementation-specific or other considerations, the fixtures 114 are items that can be moved within the facility 104 to achieve a specific configuration. For example, a fixture can be a moveable table which can be positioned at different locations within the facility 104 to display different products. The fixtures 114 can be selected and positioned within the facility 104 according to configuration instructions received from an applicable system for managing flash retailing, such as the flash retailing management systems described in this paper.

The facility operators 116 function to configure the facility 104 for purposes of selling products through flash retailing. The facility operators 116 can configure the facility 104 according to configuration instructions received through the facility operator devices 120. For example, a facility operator device 120 can be a wireless tablet that receives configuration instructions from a flash retailing management system, which the facility operators 116 can then user to configure the facility 104. In various implementations, the facility operators 116 can process selling of products and/or demo products for customers. For example, a facility operator 116 can be instructed to demo a product through the facility operator devices 120 and subsequently demo the product for a customer.

The facility monitoring devices 118 include applicable devices for monitoring consumer interactions at the facility 104. For example, the facility monitoring devices 118 can include cameras used to capture images for facial recognition of consumers as they interact with products. In another example, the facility monitoring devices 118 can include tablets positioned next to products used to gather information regarding user experiences, e.g. take images of a user as they interact with the products. Depending upon implementation-specific or other considerations, the facility monitoring devices 118 are used, at least in part, to maintain consumer profiles, traffic flow data, and/or product analytics data. The facility monitoring devices 118 can communicate with an applicable system for managing flash retailing, such as the flash retailing management systems described in this paper. Further depending upon implementation-specific or other considerations, the facility monitoring devices 118 can include beacons or other applicable low power communications devices for tracking consumer movement at the facility 104.

The facility display systems 122 include applicable devices for displaying information to consumers at the facility 104. Facility display systems 122 can include displays for presenting advertisements to users. Depending upon implementation-specific or other considerations, the facility display systems 122 can be controlled by an applicable system for managing flash retailing, such as the flash retailing management systems described in this paper. Further depending upon implementation-specific or other considerations, facility display systems 122 can be used to present product information to consumers. For example, the facility display systems 122 can include tablets positioned next to products and configured to display specifications and reviews of the products. Further depending upon implementation-specific or other considerations, the facility display systems 122 include devices at a check-in kiosk. For example, the facility display systems 122 can include a tablet at a check-in kiosk displaying available appointments for demonstrations of a product.

In an example of operation of the example system shown in FIG. 1, the product developer system 108 provides input regarding a retailer system and a facility for purposes of flash retailing products created by the product developer to the flash retailing management system 110. In the example of operation of the example system shown in FIG. 1, the flash retailing management system 110 configures the retailer system to offer in an online market place the products according to the input received from the product developer system 108. Further, in the example of operation of the example system shown in FIG. 1, the flash retailing management system 110 configures the facility 104 to sell the products through flash retailing based on the input received from the product developer through the product developer system 108.

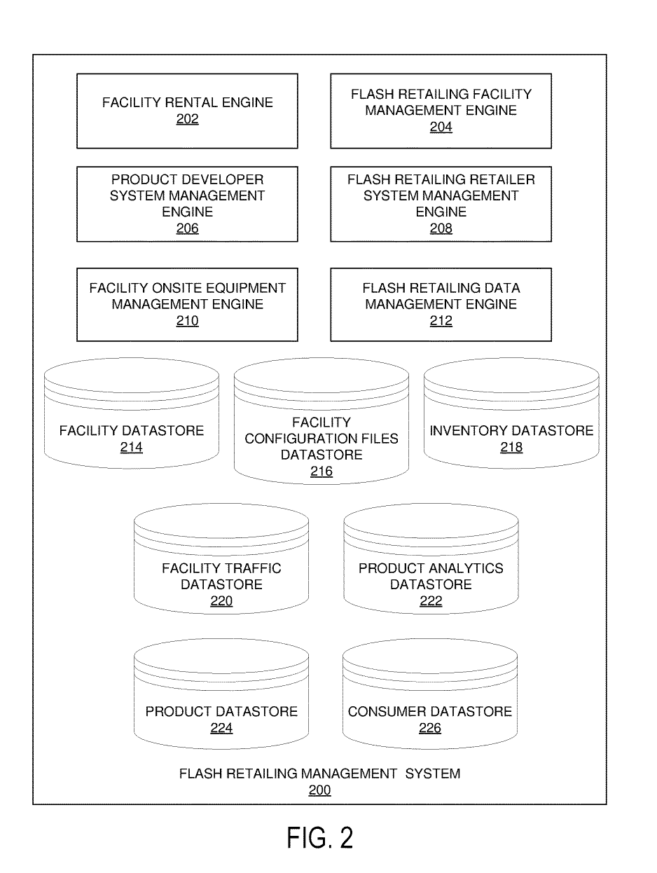

FIG. 2 depicts a diagram of an example of a flash retailing management system 200. The flash retailing management system functions according to an applicable system for managing flash retailing of products, such as the flash retailing management systems described in this paper. Depending upon implementation-specific or other considerations, the flash retailing management system 200 can be used to obtain a right to occupy space at a facility as part of flash retailing. For example, the flash retailing management system 200 can be used to sell a product as part of flash retailing at a physical location. Further depending upon implementation-specific or other considerations, the flash retailing management system 200 can configure a retailer system for purposes of selling products included as part of flash retailing. For example, the flash retailing management system 200 can configure an online store of a retailer to sell products as part of flash retailing. Depending upon implementation-specific or other considerations, the flash retailing management system 200 can configure a facility for purposes of selling products as part of flash retailing. For example, the flash retailing management system 200 can instruct a facility how to place products at a facility for purposes of selling the products through flash retailing.

The example flash retailing management system 200 shown in FIG. 2 includes a facility rental engine 202, a flash retailing flash retailing facility management engine 204, a product developer system management engine 206, a flash retailing retailer system management engine 208, a facility hardware management engine 210, a flash retailing data management engine 212, a facility datastore 214, a facility configuration files datastore 216, an inventory datastore 218, a facility traffic datastore 220, a product analytics datastore 222, a product datastore 224, and a consumer datastore 226.

The facility rental engine 202 functions to manage securing of a right to have a product sold through flash retailing. Depending upon implementation-specific or other considerations, the facility rental engine 202 can secure a right to have a product sold through flash retailing at a facility. For example, the facility rental engine 202 can reserve physical space at a facility at which a product can be displayed. Further depending upon implementation-specific or other considerations, the facility rental engine 202 can secure a right to have a product sold through a retailer system. For example, the facility rental engine 202 can secure a right to have a product sold in an online store of a retailer system through flash retailing. In various implementations, the facility rental engine 202 can manage securing of a right to have a product sold through flash retailing based on input from a product developer of the product. For example, the facility rental engine 202 can reserve a right to have a product sold through flash retailing according to an agreed upon price or price structure. Depending upon implementation-specific or other considerations, the facility rental engine 202 can secure a right to sell a product through flash retailing in accordance with a received rent request.

The flash retailing flash retailing facility management engine 204 functions to manage a facility for purposes of selling products through flash retailing. In managing a facility, the flash retailing flash retailing facility management engine 204 can cause a facility to be configured to a desired configuration. For example, the flash retailing flash retailing facility management engine 204 can cause products and fixtures within a facility to be positioned according to a desired configuration. Depending upon implementation-specific or other considerations, in managing a facility, the flash retailing flash retailing facility management engine 204 can communicate with facility operators through facility operator devices for purposes of configuring a facility. For example, the flash retailing flash retailing facility management engine 204 can send configuration instructions to facility operators detailing where to place specific products within a facility as part of flash retailing. In another example, the flash retailing flash retailing facility management engine 204 can send product information describing how to demonstrate a product to facility operators for use in demonstrating the product to customers.

In a specific implementation, the flash retailing flash retailing facility management engine 204 functions to configure a facility for purposes of flash retailing according to facility configuration input received from a product developer. In configuring a facility according to facility configuration input, the flash retailing flash retailing facility management engine 204 can generate configuration instructions based on the facility configuration input, and provide the configuration instructions to facility operators for use in configuring the facility to achieve a desired configuration. Depending upon implementation-specific or other considerations, the flash retailing flash retailing facility management engine 204 can generate configuration instructions from facility configuration input and pre-defined facility configurations. For example, if facility configuration input indicates a product developer wants a specific pre-defined facility configuration of a plurality of pre-defined facility configurations, then the flash retailing flash retailing facility management engine 204 can generate configuration instructions indicating to configure a facility according to the specific pre-defined facility configuration. Further depending upon implementation-specific or other considerations, the flash retailing flash retailing facility management engine 204 can generate configuration instructions from facility configuration input indicating a customized configuration for a product developer. For example, if facility configuration input indicates a product developer wants modifications to a pre-defined facility configuration, then the flash retailing flash retailing facility management engine 204 can generate configuration instructions indicating the modifications.

In a specific implementation, the flash retailing flash retailing facility management engine 204 functions to use product analytics data in configuring a facility for purposes of flash retailing. Depending upon implementation-specific or other considerations, the flash retailing flash retailing facility management engine 204 functions to use product analytics data of a specific type of product in configuring a facility for purposes of flash retailing. For example, if a product developer wants to flash retail a product of a specific type at a facility, and product analytics data indicates that products of the specific type should be demonstrated at the back of the facility to sell the greatest amount of the products, then the flash retailing flash retailing facility management engine 204 can configure the facility to have the product demonstrated in the back of the facility. Further depending upon implementation-specific or other considerations, the flash retailing flash retailing facility management engine 204 functions to use product analytics data of a specific product in configuring a facility for purposes of flash retailing. For example, if a product developer wants to flash retail a specific product at a facility, and product analytics data indicates that the specific product should be displayed at the front of the facility to sell the greatest amount of the specific product, then the flash retailing flash retailing facility management engine 204 can configure the facility to have the product displayed at the front of the facility.

In a specific implementation, the flash retailing flash retailing facility management engine 204 functions to manage display of advertisements at a facility for flash retailing. In managing display of advertisements, the flash retailing flash retailing facility management engine 204 can select what advertisements to display at a facility. Depending upon implementation-specific or other considerations, the flash retailing flash retailing facility management engine 204 can receive product information from a product developer including an advertisement for a specific product and subsequently select the advertisement based on the product information. Further depending upon implementation-specific or other considerations, the flash retailing flash retailing facility management engine 204 can select advertisements to display at a facility based on product analytics data. For example, if product analytics data indicates consumers purchase more of a product when a specific advertisement is displayed, then the flash retailing flash retailing facility management engine 204 can select the specific advertisement for display when the product is sold through flash retailing at a facility.

The product developer system management engine 206 functions to interact with a product developer. In interacting with a product developer, the product developer system management engine 206 can send data related to flash retailing to a product developer and receive data related to flash retailing from the product developer. In various implementations, the product developer system management engine can receive a rent request for securing a right to flash retail a product from a product developer. Depending upon implementation-specific or other considerations, the product developer system management engine 206 can send product analytics data to a product developer. For example, the product developer system management engine 206 can send product analytics data indicating how many times a consumer viewed a demonstration of a product at a facility. In another example, the product developer system management engine 206 can send product analytics data indicating which product bundles consumers were most likely to purchase through an online store as part of a retailer system. Further depending upon implementation-specific or other considerations, the product developer system management engine 206 can send consumer profiles to a product developer. In various implementations, the product developer system management engine 206 can send consumer profiles grouped according to market segmentation variables. For example, the product developer system management engine 206 can send consumer profiles of consumers within a market segment.

In a specific implementation, the product developer system management engine 206 functions to receive facility configuration input from a product developer. Depending upon implementation-specific or other considerations, the product developer system management engine 206 can receive facility configuration input from a product developer. For example, the product developer system management engine 206 can receive facility configuration input indicating a desired facility configuration by a product developer for use in configuring a facility to sell products through flash retailing. Further depending upon implementation-specific or other considerations, the product developer system management engine 206 can present pre-defined facility configurations to a product developer for use in generating facility configuration input from the product developer. For example, the product developer system management engine 206 can present to a product developer pre-defined facility configurations for a specific product type of a product the product developer is attempting to sell through flash retailing. Depending upon implementation-specific or other considerations, the product developer system management engine 206 can receive facility configuration input indicating a desired customized facility configuration of a facility for selling products through flash retailing.

The flash retailing retailer system management engine 208 functions to manage a retailer system for purposes of selling products through flash retailing. In managing a retailer system, the flash retailing retailer system management engine 208 can cause a retailer system to be configured to a desired configuration. For example, the flash retailing retailer system management engine 208 can cause a retailer system to sell products as part of flash retailing. Depending upon implementation-specific or other considerations, the flash retailing retailer system management engine 208 can inject code into or modify code of a retailer system to cause the retailer system to sell products through flash retailing. For example, the flash retailing retailer system management engine 208 can inject or modify code of a retailer systems online store to sell a product through flash retailing.

In a specific implementation, the flash retailing retailer system management engine 208 functions to configure a retailer system for purposes of flash retailing according to retail configuration input received from a product developer. The flash retailing retailer system management engine 208 can configure a retailer system by generating and sending configuration instructions indicating how a retailer system should be configured to sell a product to the retailer system. Depending upon implementation-specific or other considerations, the flash retailing retailer system management engine 208 can configure a retailer system according to pre-defined retailer configurations. For example, if retailer configuration input indicates a product developer wants a specific pre-defined retail configuration of a plurality of pre-defined retail configurations, then the flash retailing retailer system management engine 208 can modify a retailer system to achieve the specific pre-defined retail configuration. Further depending upon implementation-specific or other considerations, the flash retailing retailer system management engine 208 can modify a retailer system according to retail configuration input indicating a customized configuration of a retailer system for a product developer. For example, if retail configuration input indicates a product developer wants modifications to a pre-defined retailer configuration, then the flash retailing retailer system management engine 208 can modify a retail configuration of a retailer system according to the modification to the pre-defined retailer configuration.

In a specific implementation, the flash retailing retailer system management engine 208 functions to use product analytics data in configuring a retailer system for purposes of flash retailing. Depending upon implementation-specific or other considerations, the flash retailing retailer system management engine 208 functions to use product analytics data of a specific type of product in configuring a retailer system for purposes of flash retailing. For example, if a product developer wants to flash retail a product of a specific type through a retailer, and product analytics data indicates that products of the specific type should be bundled with other specific products to increase sales of the product of the specific type, then the flash retailing retailer system management engine 208 can configure a retailer system to display the products together. Further depending upon implementation-specific or other considerations, the flash retailing retailer system management engine 208 functions to use product analytics data of a specific product in configuring a retailer system for purposes of flash retailing. For example, if a product developer wants to flash retail a specific product using a retailer system, and product analytics data indicates that the specific product should be displayed with other products to increase the sales of the specific product, then the flash retailing retailer system management engine 208 can instruct a retailer system to offer the two products together. Further in the example, the retailer can be instructed by sending a retailer system configuration instructions indicating to offer the two products together.

In a specific implementation, the flash retailing retailer system management engine 208 functions to manage display of advertisements through a retailer system as part of flash retailing. In managing display of advertisements, the flash retailing retailer system management engine 208 can select what advertisements to display on an online store of a retailer system. Depending upon implementation-specific or other considerations, the flash retailing retailer system management engine 208 can receive product information from a product developer including an advertisement for a specific product and subsequently select the advertisement based on the product information. Further depending upon implementation-specific or other considerations, the flash retailing retailer system management engine 208 can select advertisements to display on a retailer system based on product analytics data. For example, if product analytics data indicates consumers purchase more of a product when a specific advertisement is displayed, then the flash retailing retailer system management engine 208 can select the specific advertisement for display when the product is sold as part of flash retailing through a retailer system.

In a specific implementation, the flash retailing retailer system management engine 208 functions to interact with a retailer. In interacting with a retailer, the flash retailing retailer system management engine 208 can send data related to flash retailing to a retailer and receive data related to flash retailing from the retailer. Depending upon implementation-specific or other considerations, the flash retailing retailer system management engine 208 can send product analytics data to a retailer. For example, the flash retailing retailer system management engine 208 can send product analytics data indicating how many times a consumer viewed a product through an online store provided by a retailer system. In another example, the flash retailing retailer system management engine 208 can send product analytics data indicating which product bundles consumers were most likely to purchase through an online store as part of a retailer system. Further depending upon implementation-specific or other considerations, the flash retailing retailer system management engine 208 can send consumer profiles to a retailer. In various implementations, the flash retailing retailer system management engine 208 can send consumer profiles grouped according to market segmentation variables. For example, the flash retailing retailer system management engine 208 can send consumer profiles of consumers within a market segment.

The facility onsite equipment management engine 210 functions to manage onsite equipment at a facility used for flash retailing. In managing onsite equipment, the facility onsite equipment management engine 210 can send data to onsite equipment and receive data from onsite equipment. For example, the facility onsite equipment management engine 210 can receive data captured from facility monitoring devices used to generate facility traffic data. In another example, the facility onsite equipment management engine 210 can send product information to facility operator devices for purposes of selling products through flash retailing.

In a specific implementation, the facility onsite equipment management engine 210 functions to send data for use in configuring a facility for flash retailing. In various implementations, the facility onsite equipment management engine 210 can send configuration instructions generated by an applicable engine for generating configuration instructions for flash retailing, such as the flash retailing flash retailing facility management engines described in this paper. For example, the facility onsite equipment management engine 210 can send configuration instructions generated in response to facility configuration input received from a product developer. Further in the example, the facility onsite equipment management engine 210 can send the configuration instructions to facility operators through facility operator devices, who can configure the facility in response to the instructions.

In a specific implementation, the facility onsite equipment management engine 210 functions to control display of advertisements at a facility for flash retailing. The facility onsite equipment management engine 210 can control of display of advertisements selected by an applicable engine for selecting advertisements to display at a flash retailing facility, such as the flash retailing flash retailing facility management engines described in this paper. In various implementations, the facility onsite equipment management engine 210 can send an advertisement to display along with advertising instructions to an in-facility display system. Advertising instructions can include applicable data related to display of advertisements, e.g. a length of time to display advertisements. An applicable engine for selecting an advertisement to display at a flash retailing facility, such as the flash retailing flash retailing facility management engines described in this paper, can generate advertising instructions.

The flash retailing data management engine 212 functions to manage data used in flash retailing. Depending upon implementation-specific or other considerations, the flash retailing data management engine 212 can use data gathered from onsite equipment at a facility to maintain data used in flash retailing. For example, the flash retailing data management engine 212 can use data gathered from cameras at a facility for purposes of maintaining data used in flash retailing. Further depending upon implementation-specific or other considerations, the flash retailing data management engine 212 can use data gathered form a retailer system in maintaining data used in flash retailing. For example, the flash retailing data management engine 212 can use data about sales of a flash retailed product through an online store of a retailer system to maintain data used in flash retailing.

In a specific implementation, the flash retailing data management engine 212 functions to maintain facility data. Facility data can include applicable data related to a facility used in flash retailing. For example, facility data can include products being sold at a facility through flash retailing, product developers who are using or have used a facility, a current configuration of a facility, and past configurations of a facility. The flash retailing data management engine 212 can maintain facility data based on data received from onsite equipment at a facility.

In a specific implementation, the flash retailing data management engine 212 functions to maintain facility configuration files data. Facility configuration files data include pre-defined configurations of a facility. For example, facility configuration files data can indicate where to position products and fixtures in a facility. Depending upon implementation-specific or other considerations, facility configuration files data can be created by facility operators and sent to the flash retailing data management engine 212 using facility operator devices.

In a specific implementations, the flash retailing data management engine 212 functions to manage inventory data. Inventory data indicates an inventory of products at a facility sold through flash retailing. Inventory data can be used by an applicable system for managing a facility, such as the flash retailing facility management engines described in this paper, to manage inventory of products at the facility. For example, if inventory data indicates an amount of a product at a facility is running low, then an applicable engine for managing a facility offering flash retailing can order more product for the facility, such as the flash retailing facility management engines described in this paper. Depending upon implementation-specific or other considerations, inventory data can be maintained using facility operators. For example, if facility operators indicate an amount of a product they have sold, then the flash retailing data management engine 212 can update inventory data to reflect the amount of the product sold.

In a specific implementation, the flash retailing data management engine 212 functions to maintain facility traffic data. Facility traffic data maintained by the flash retailing data management engine 212 can be generated using data received from onsite equipment at a facility. For example, the flash retailing data management engine 212 can generate facility traffic data from feeds received from cameras onsite at a facility.

In a specific implementation, the flash retailing data management engine 212 functions to maintain product analytics data. In maintain product analytics data, the flash retailing data management engine 212 can generate product analytics data. Depending upon implementation-specific or other consideration, the flash retailing data management engine 212 can maintain product analytics data using facility traffic data. For example, if a product received increased traffic when placed in back of a facility instead of in front, as indicated by facility traffic data, then the flash retailing data management engine 212 can update product analytics data to indicate the product receives more foot traffic when it is placed in back of a facility as opposed to being placed in front. Further depending upon implementation-specific or other considerations, the flash retailing data management engine 212 can maintain product analytics data based on data received from an applicable entity for selling a product. For example, the flash retailing data management engine 212 can maintain product analytics data based on sales data received from a facility operator or an online store provided by a retailer system.

In a specific implementation, the flash retailing data management engine 212 functions to maintain product information. The flash retailing data management engine 212 can maintain product information based on data received from a product developer. For example, the flash retailing data management engine 212 can maintain product information based on specification of a product received from a product developer. In another example, the flash retailing data management engine 212 can maintain product information based on advertisements received from a product developer.

In a specific implementation, the flash retailing data management engine 212 functions to maintain consumer data indicating consumer profiles. Depending upon implementation-specific or other considerations, the flash retailing data management engine 212 can segment consumers into market segments in maintaining consumer data. For example, the flash retailing data management engine 212 can segment together all consumer who are males and under the age of 25. The flash retailing data management engine 212 can maintain consumer data based on data received from onsite equipment at a facility used in flash retailing. For example, the flash retailing data management engine 212 can use data entered into a front kiosk at a facility to generate consumer data. The flash retailing data management engine 212 can maintain consumer data can maintain consumer data based on data received from a retailer system. For example, the flash retailing data management engine 212 can use data input into an online store by a consumer to maintain consumer data.

The facility datastore 214 functions to store facility data. Facility data stored in the can be generated based on management of a facility providing flash retailing. The facility configuration files datastore 216 functions to store facility configuration files data. Facility configuration files data stored in the facility configuration files datastore 216 can indicate pre-defined facility configurations. The inventory datastore 218 functions to store inventory data. Inventory data stored in the inventory datastore 218 can indicate an inventory of products sold through flash retailing. The facility traffic datastore 220 functions to store facility traffic data. Facility traffic data stored in the facility traffic datastore 220 can indicate facility traffic at a facility selling products through flash retailing. The product analytics datastore 222 functions to store product analytics data. Product analytics data stored in the product analytics datastore 222 can be generated based on facility traffic data. The product datastore 224 functions to store product information. Product information stored in the product datastore 224 can be received from product developers. The consumer datastore 226 functions to store consumer data indicating consumer profiles of consumers of products offered through flash retailing.

In an example of operation of the example system shown in FIG. 2, the flash retailing data management engine 212 maintains facility data stored in the facility datastore 214 using data gathered from onsite equipment at a facility by the facility onsite equipment management engine 210. In the example of operation of the example system shown in FIG. 2, the flash retailing data management engine 212 maintains facility configuration files data stored in the facility configuration files datastore 216. Further, in the example of operation of the example system shown in FIG. 2, the flash retailing data management engine 212 maintains inventory data stored in the inventory datastore 216 using data gathered from the onsite equipment by the facility onsite equipment management engine 210. In the example of operation of the example system shown in FIG. 2, the flash retailing data management engine 212 maintains inventory data stored in the inventory datastore 216 using data gathered from the onsite equipment by the facility onsite equipment management engine 210.

In the example of operation of the example system shown in FIG. 2, the flash retailing data management engine 212 maintains product analytics data stored in the product analytics datastore 222 using the facility traffic data stored in the facility traffic datastore 220. In the example of operation of the example system shown in FIG. 2, the flash retailing data management engine 212 maintains product information stored in the product datastore 224 using data received by the product developer system management engine 210. Further, in the example of operation of the example system shown in FIG. 2, the flash retailing data management engine 212 maintains consumer data stored in the consumer datastore 226 using data gathered from the onsite equipment by the facility onsite equipment management engine 210.

In the example of operation of the example system shown in FIG. 2, the flash retailing facility management engine 204 manages the facility for purposes of flash retailing using facility configuration input received from a product developer through the product developer system management engine 206 and the product analytics data. Further, in the example of operation of the example system shown in FIG. 2, the flash retailing retailer system management engine 208 manages a retailer system for purposes of flash retailing through the retailer system using retailer configuration input received from the product developer through the product developer system management engine 206 and the product analytics data.

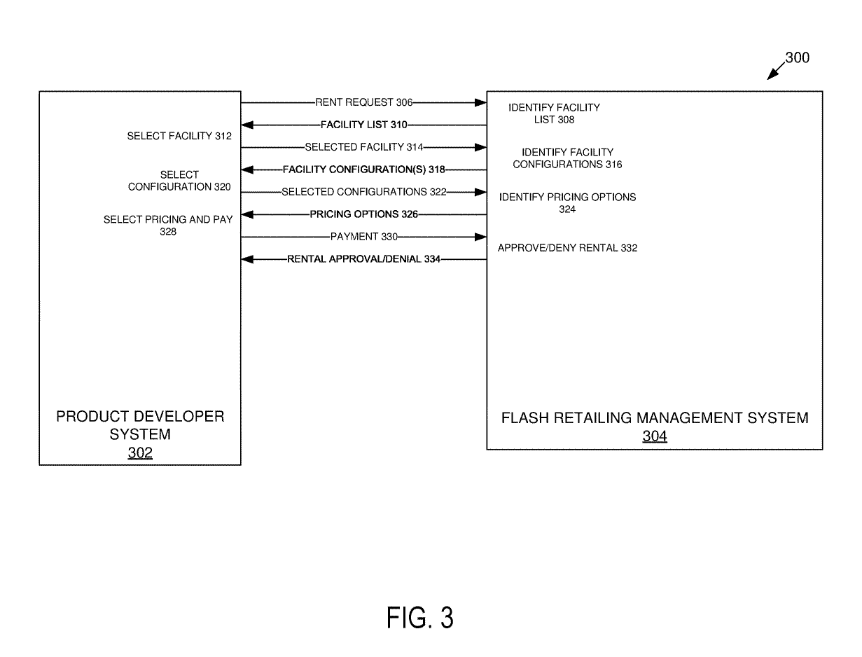

FIG. 3 depicts a diagram 300 of an example of a system for securing a right to use a facility for flash retailing. Depending upon implementation-specific or other considerations, a right to use a facility for flash retailing includes a right to have a product demonstrated at a facility. Further depending upon implementation-specific or other considerations, a right to use a facility for flash retailing includes a right to have a product displayed at a facility. The example system shown in FIG. 3 includes a product developer system 302 and a flash retailing management system 304.

The product developer system 302 functions according to an applicable system for allowing a product developer to manage flash retailing of their products, such as the product developer systems described in this paper. Depending upon implementation-specific or other considerations, the product developer system 302 can be implemented, at least in part, through a native application executing at a client device of a product developer. Further depending upon implementation-specific or other considerations, the product developer system 302 can be implemented, at least in part, through a web-based application accessed through a web browser executing at a client device of a product developer. In various implementations, through the product developer system 302, a product developer can provide input for use in managing flash retailing.

The flash retailing management system 304 functions according to an applicable system for managing flash retailing of products, such as the flash retailing management systems described in this paper. Depending upon implementation-specific or other considerations, the flash retailing management system 304 functions to provide data to the product developer system 302 for managing flash retailing of their products. For example, the flash retailing management system 304 can provide product analytics data to a product developer through the product developer system 302. Depending upon implementation-specific or other considerations, the flash retailing management system 304 can configure a facility for selling a product of a product developer through flash retailing. Further depending upon implementation-specific or other considerations, the flash retailing management system 304 can configure a retailer system to sell a product as part of flash retailing.

The process of securing a right to use a facility for flash retailing using the product developer system 302 and the flash retailing management system 304 begins at module 306, where a rent request is sent from the product developer system 302 to the flash retailing management system 304. A rent request can include an identification of product to be sold as part of flash retailing, a location, e.g. a city, in which a product developer wants the product to be sold, and a rental type, e.g. if the product developer just wants to rent a right to have their product displayed or if the product developer wants to rent a right to have their product demonstrated.

At module 308, a facility list is identified by the flash retailing management system 304 based on the rent request sent at module 306. An applicable engine for managing facility rental for purposes of flash retailing, such as the facility rental engines described in this paper, can identify a facility list based on the rent request. Depending upon implementation-specific or other considerations, a facility lists can be identified at module 308 based on a location specified in the rent request. For example, if a rent request indicates that a product developer wants to sell their product within a specific city, then a facility list of facilities for selling products through flash retailing in the specific city can be identified. Facilities on an identified list of facilities can include facilities operated by the flash retailing management system 304 or a separate retailer. For example, facilities can include stores of a consumer electronics chain.

At module 310, the identified facility list is sent back to the product developer system 302, where a product developer can view the facility list. An applicable engine for communicating with a product developer system for purposes of flash retailing, such as the product developer system management engines described in this paper, can send the facility lists to the product developer system 302. In various implementations, the facility list can include data describing the facilities on the list. For example, the facility list can include locations of the facilities, sizes of the facilities, capabilities of operators at the facilities, traffic typically received at the facilities, and market segments of consumers who shop at the facilities.

At module 312, the product developer selects a facility from the facility list sent at module 310. At module 314, the product developer system 302 sends to the flash retailing management system 304, input indicating a specific facility or plurality of facilities a product developer has selected from the facility list for purposes of flash retailing products. An applicable engine for communicating with a product developer system for purposes of flash retailing, such as the product developer system management engines described in this paper, can receive input indicating a specific facility a product developer wants to use for selling a product as part of flash retailing.

At module 316, facility configurations for the selected facility are identified by the flash retailing management system 304. An applicable engine for managing facility configuration for purposes of flash retailing, such as the flash retailing facility management engines described in this paper, can identify a facility configuration for the facility. Facility configurations can include pre-defined configurations. Pre-defined configurations can be specific to the facility. In various implementations, facility configurations for the facility can be determined from facility configuration files data.

At module 318 the facility configurations identified at module 316 are returned to the product developer system. At module 320 a facility configuration is selected by the product developer using the product developer system and subsequently at module 322 the selected configuration is sent back to the flash retailing management system 304. An applicable engine for communicating with a product developer for purposes of flash retailing, such as the product developer system management engines described in this paper, can send identifications of the facility configurations to the product developer system 302 and receive input regarding a selected configuration, e.g. as facility configuration input.

At module 324, pricing options/price structures for securing a right to sell products at the facility through flash retailing are identified. An applicable engine for managing renting of a facility for purposes of flash retailing, such as the facility rental engines described in this paper, can identify pricing options. Depending upon implementation-specific or other considerations, pricing options can depend on a product to sell as part of flash retailing and/or services a product developer wants as part of selling the product through flash retailing. For example pricing options can depend on whether a product developer wishes to have their product demonstrated at a facility. Further depending upon implementation-specific or other consideration, pricing options can depend on characteristics of the selected facility and/or the selected facility configuration. For example, if the selected facility is in a traffic area that receives more consumer traffic than other facilities, then the pricing options for the selected facility can be different from pricing options for the other facilities.

At module 326, the pricing options identified at module 324 are sent to the product developer system 302. An applicable engine for communicating with a product developer system for purposes of flash retailing, such as the product developer system management engines described in this paper, can send the pricing options to the product developer system 302. At module 328, a product developer selects a pricing option from the pricing options sent at module 326.

At module 330, payment is sent to the flash retailing management system 304. An applicable engine for communicating with a product developer system for purposes of flash retailing, such as the product developer system management engines described in this paper, can facilitate transfer of payment from the product developer system 302 to the flash retailing management system 304. After payment is received, at module 332, the flash retailing management system 304 determines whether to approve or deny rental of the facility for the product developer. An applicable engine for securing rental of a facility for purposes of flash retailing, such as the facility rental engines described in this paper, can approve or deny rental of the facility and subsequently schedule or obtain for the product developer the right to sell a product at the facility through flash retailing. At module 334, the product developer is sent confirmation indicating whether the rent of the facility was approved or denied.

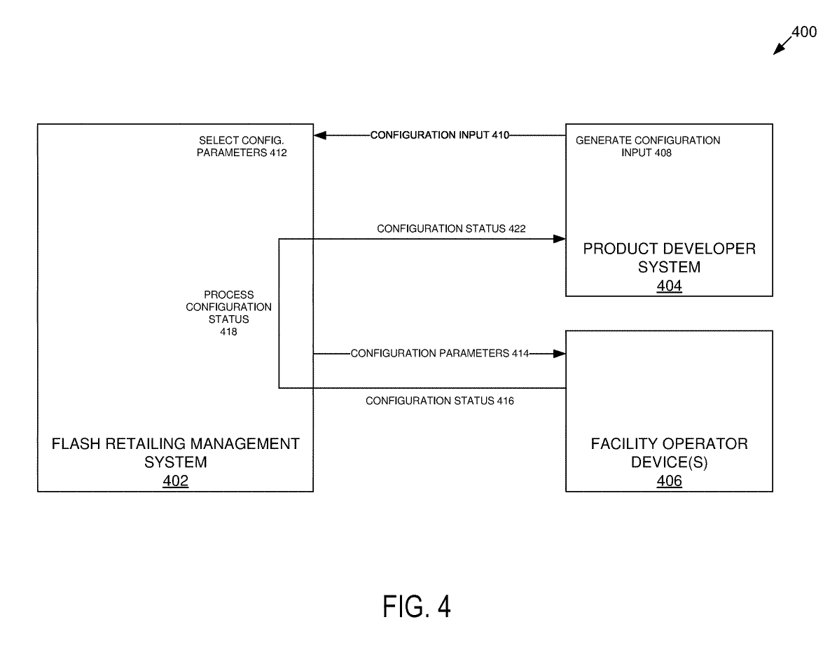

FIG. 4 depicts a diagram 400 of an example of a system for configuring a facility for flash retailing according to a product developer. The example system shown in FIG. 4 includes a flash retailing management system 402, a product developer system 404 and facility operator devices 406.

The flash retailing management system 402 functions according to an applicable system for managing flash retailing of products, such as the flash retailing management systems described in this paper. Depending upon implementation-specific or other considerations, the flash retailing management system 402 can exchange data with a product developer system for managing flash retailing of their products. For example, the flash retailing management system 402 can provide configuration status data to a product developer indicating a status of configuration of a facility for selling products through flash retailing. Depending upon implementation-specific or other considerations, the flash retailing management system 402 can configure a retailer system and/or a facility to sell products as part of flash retailing.

The product developer system 404 functions according to an applicable system for allowing a product developer to manage flash retailing of their products, such as the product developer systems described in this paper. Depending upon implementation-specific or other considerations, the product developer system 404 can be implemented, at least in part, through a native application executing at a client device of a product developer. Further depending upon implementation-specific or other considerations, the product developer system 404 can be implemented, at least in part, through a web-based application accessed through a web browser executing at a client device of a product developer. In various implementations, through the product developer system 404, a product developer can provide input for use in managing flash retailing.

The facility operator devices 406 function according to applicable devices at a facility for managing sale of products through flash retailing. Depending upon implementation-specific or other considerations, the facility operator devices 406 are portable devices that can be carried by facility operators. For example, the facility operator devices 406 can be tablets used by a facility operator to receive instructions on how to configure a facility. In another example, the facility operator devices 406 can be tablets used by a facility operator to view a schedule of demonstrations of a product as part of flash retailing. The facility operator devices 406 can be used by facility operators to configure a facility for purposes of flash retailing.

The process of configuring a facility for flash retailing using the system shown in FIG. 4 begins at module 408 where configuration input, e.g. facility configuration input, is generated at the product developer system 404. Depending upon implementation-specific or other considerations, facility configuration input can be generated at the product developer system 404 based on pre-defined configuration patterns for a facility presented to a product developer through the product developer system 404. Further depending upon implementation-specific or other considerations, facility configuration input generated at the product developer system 404 can indicate custom configurations of a product developer. For example, facility configuration input generated at the product developer system 404 can indicate custom modifications to a pre-defined configuration of a facility.

At module 410, the configuration input is sent to the flash retailing management system 402. An applicable engine for communicating with a product developer system for purposes of flash retailing, such as the product developer system management engines described in this paper, can receive the configuration input from the product developer system 404. Depending upon implementation-specific or other considerations, the configuration input sent at module 410 can indicate a desire to configure a facility according to a pre-defined configuration or a custom facility configuration.

At module 412, configuration parameters are selected. The configuration parameters are selected based on the configuration input sent from the product developer system 404 at module 410. Configuration parameters include applicable parameters in which a facility can be configured to drive sales of products through flash retailing. For example, configuration parameters can include where to place a product and fixtures in selling a product through flash retailing. In another example, configuration parameters can include whether to demonstrate a product at a facility for selling the product through flash retailing.

At module 414, the configuration parameters are sent to the facility operator devices 406. The configuration parameters can be sent, as part of configuration instructions, to facility operator devices by an applicable engine for sending configuration parameters to the facility operator devices 406, such as the facility onsite equipment management engines described in this paper. The configuration parameters can be sent as part of configuration instructions to the facility operator devices 406.

At module 416, the facility operator devices 406 send a configuration status to the flash retailing management system 402. A configuration status can indicate how much a facility has been configured according to the configuration instructions. An applicable system for communicating with onsite devices at a facility offering flash retailing, such as the facility onsite equipment management engine 210 can receive a configuration status of the facility.

At module 418, the flash retailing management system 402 processes the configuration status received from the facility operators. An applicable engine for managing a facility in flash retailing, such as the flash retailing facility management engines described in this paper, can process the configuration status received at module 416. A configuration status can include steps needed to achieve a desired configuration of a facility and steps that have been accomplished in achieving the desired configuration. For example, a configuration status can include that the facility operators still need to be trained to demonstrate a product.

At module 422, the configuration status is displayed for the product developer through the product developer system 404. An applicable engine for communicating with a product developer system for purposes of flash retailing, such as the product developer system management engines described in this paper, can communicate the configuration status to the product developers. Depending upon implementation-specific or other considerations, the configuration status can be displayed for the product developer through a web-based application accessed through a web browser executing at the product developer system 404, or a native application executing at the product developer system 404.

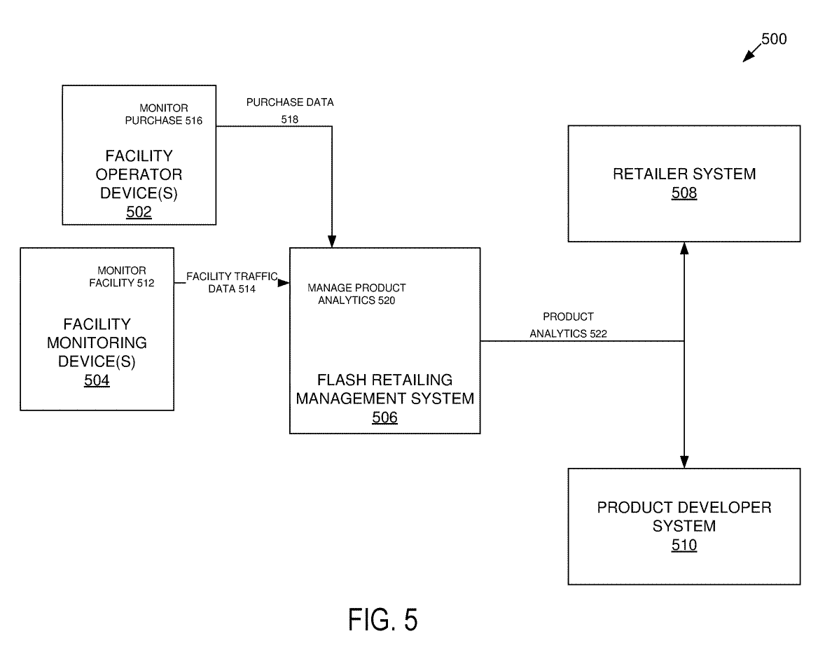

FIG. 5 depicts a diagram 500 of an example of a system for maintaining product analytics data for products flash retailed at a facility. The example system shown in FIG. 5 includes facility operator devices 502, facility monitoring devices 504, a flash retailing management system 506, a retail system 508, and a product developer system 510.

The facility operator devices 502 function according to applicable devices used by facility operators of a facility at which products are sold through flash retailing, such as the facility operator devices described in this paper. Depending upon implementation-specific or other considerations, the facility operator devices 502 can be used to complete a transaction of a sale of a product sold at a facility through flash retailing. For example, the facility operator devices 502 can include devices with credit card readers for carrying out transactions at a facility. Further depending upon implementation-specific or other considerations, the facility operator devices 502 can be used for communicating with an applicable engine for managing facility configuration for purposes of flash retailing, such as the flash retailing facility management engines described in this paper. For example, the facility operator devices 502 can receive configuration instructions which can be used by facility operators to configure a facility.

The facility monitoring devices 504 function according to applicable devices for monitoring consumer interactions at a facility used for purposes of flash retailing, such as the facility monitoring devices described in this paper. For example, the facility monitoring devices 504 can include cameras used to capture movements of consumers within a facility. In another example, the facility monitoring devices 504 can include tablets positioned next to products and used to gather information regarding user experiences, e.g. take images of a user as they interact with the products.

The flash retailing management system 506 functions according to an applicable system for managing sales of product through flash retailing, such as the flash retailing management systems described in this paper. Depending upon implementation-specific or other considerations, the flash retailing management system 506 functions to exchange data with a product developer system for managing flash retailing of their products. For example, the flash retailing management system 506 can provide product analytics data of a product to a product developer. Depending upon implementation-specific or other considerations, the flash retailing management system 506 can configure a retailer system to sell products as part of flash retailing. For example, the flash retailing management system 506 can provide configuration instructions to a retailer for configuring their retailer system to sell products through flash retailing.

The retailer system 508 functions according to an applicable system for selling products, such as the retailer systems described in this paper. The retailer system 508 can be implemented, at least in part, through an online store. For example, the retailer system 508 can include an online store provided by the retailer system 508 through which customers can purchase products offered through flash retailing.

The product developer system 510 functions according to an applicable system through which a product developer can manage flash retailing of their products, such as the product developer systems described in this paper. Depending upon implementation-specific or other considerations, a product developer can provide input for use in managing flash retailing of their products through the product developer system 510. For example, a product developer can provide facility configuration input through the product developer system 510, for use in configuring a facility to offer the product developer's products through flash retailing. Further depending upon implementation-specific or other considerations, a product developer can receive product analytics of their products offered as part of flash retailing, through the product developer system 510. For example, a product developer can receive product analytics data through the product developer system 510 and use the product analytics data to determine which market segments have higher demand for their products.

The process of maintaining product analytics data of products offered through flash retailing using the system shown in FIG. 5 begins at module 512 where a facility at which products are being offered through flash retailing is monitored by the facility monitoring devices 504. For example, cameras at a facility can track movements of customers through the facility in interacting with products offered at the facility through flash retailing. In another example, facial expressions of customers in interacting with product offered at a facility through flash retailing can be captured, for use in facial recognition to determine customer satisfaction levels with products.

At module 514, facility traffic data indicating consumer interactions captured at module 512 by monitoring the facility are sent to the flash retailing management system 506 from the facility monitoring devices 504. For example, a live feed showing consumer movements through the facility can be sent to the flash retailing management system 506 by cameras in the facility or tags used to track consumer movements in the facility. In another example, images capturing facial expressions of a user can be sent at module 514 to the flash retailing management system 506.

At module 516, purchasing of products offered through flash retailing at the facility is monitored by the facility operator devices. For example, facility operator devices can carry out a transaction for a purchase of a product offered at the facility through flash retailing. In another example, facility operator devices can gather consumer information, e.g. age of a consumer who purchases a product as part of monitoring purchases. At module 518, purchase data/sales data indicating whether a product was sold, what product was sold, and/or consumer data of a consumer who purchased a product is sent to the flash retailing management system 506.

At module 520, product analytics data for the products offered through flash retailing at the facility is maintained by the flash retailing management system 506. Product analytics data can be maintained using the purchase data received at module 518 and the facility monitoring data received at module 514. Depending upon implementation-specific or other considerations, Product analytics data can be maintained at the flash retailing management system 506 by correlating purchase data and facility monitoring data. For example, purchase data indicating a consumer purchased a product at a specific time can be correlated with the facility monitoring data to indicate conditions at the facility at the specific time. Further in the example, by correlating the facility monitoring data and the purchase data, it can be determined that a specific advertisement was displayed when the consumer decided to purchase the product.

At module 522, the product analytics data is provided to the retailer system 508 and the product developer system 510. Depending upon implementation-specific or other considerations, the retailer system 508 can use the product analytics data in selling of products through flash retailing. For example, if product analytics data indicates a particular product sells well using a specific advertisement, then the retailer system 508 can display the specific advertisement on an online store of the retailer system 508 used to sell the particular product. Further depending upon implementation-specific or other considerations, product developer system 510 can use product analytics data to determine which market segments have higher demand for their products.

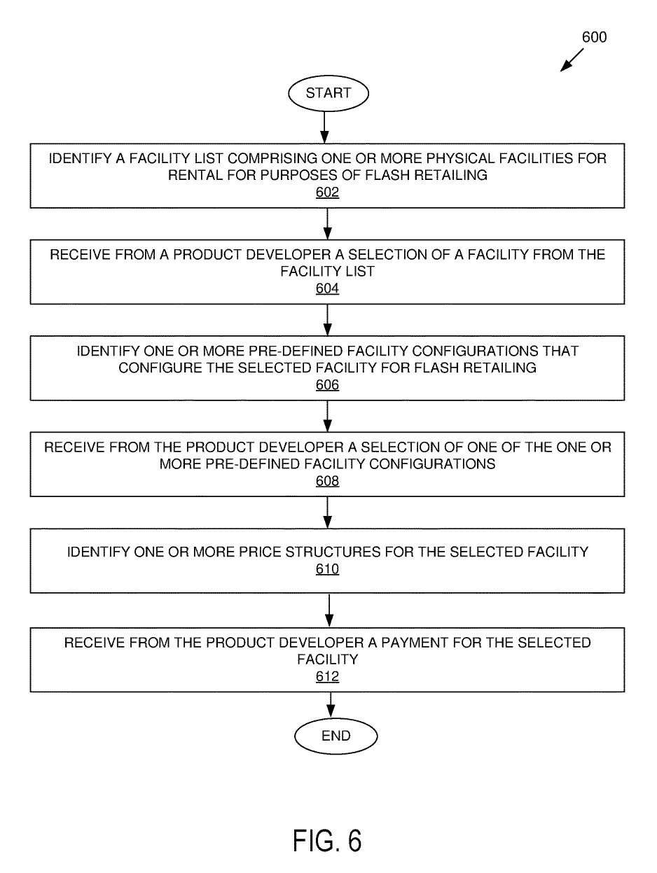

FIG. 6 depicts a flowchart 600 of an example of a method of securing a right to occupy a facility for a product developer for purposes of offering their products through flash retailing. The flowchart 600 begins at module 602, where a facility list comprising at least one physical location at which products can be sold through flash retailing is identified. An applicable engine for managing facility rental for purposes of flash retailing, such as the facility rental engines described in this paper, can identify a facility list comprising at least one physical location at which product can be sold through flash retailing. A facility list can be identified based on input received from a product developer interested in selling their product through flash retailing. For example a facility list can be identified based on input indicating a desired city in which a product developer is interested in selling their product through flash retailing.

The flowchart 600 continues to module 604, where a selection of a facility from the facility list is received from a product developer. An applicable engine for communicating with a product developer system regarding flash retailing, such as the product developer system management engines described in this paper, can receive a selection of a facility from the facility list by a product developer. A selection of a facility from the facility list can be received after sending the facility list to a product developer. Depending upon implementation-specific or other considerations facilities on the facility list can include facilities managed by a flash retailing management system or a separate retailer.

The flowchart 600 continues to module 606, where one or more pre-defined facility configurations for configuring the selected facility for flash retailing are identified. An applicable engine for managing a facility for purposes of flash retailing, such as the flash retailing facility management engines described in this paper, can identify pre-defined facility configurations for the configuring the selected facility. Pre-defined facility configurations can be identified from facility configuration files data. Depending upon implementation-specific or other considerations, identified pre-defined facility configurations can be specific to the facility selected from the facility list. For example, if the facility includes an upstairs area, then identified pre-defined facility configurations can include a configuration of the upstairs area. Further depending upon implementation-specific or other considerations, identified pre-defined facility configurations are specific to a product the product developer wants to sell at the facility through flash retailing. For example, if a product requires a connection to a display, then the identified pre-defined facility configurations can include the display.

The flowchart 600 continues to module 608, where a selection of one or more of the one or more pre-defined facility configurations is received from the product developer. An applicable engine for communicating with a product developer for purposes of flash retailing, such as the product developer system management engines described in this paper, can receive a selection of one or more of the one or more pre-defined facility configurations. A selection of one or more of the one or more pre-defined facility configurations, can be received after the one or more pre-defined facility configurations are presented to the product developer. Depending upon implementation-specific or other considerations, the one or more pre-defined facility configurations can be presented to the product developer as a schematic of the facility arranged according to the one more pre-defined facility configurations.

The flowchart 600 continues to module 610, where one or more price structures for the selected facility are identified. An applicable engine for securing a right to occupy a facility for purposes of flash retailing, such as the facility rental engines described in this paper, can identify one or more price structures for the selected facility. Price structures can include a price to obtain a right to flash retail a product at the facility. Depending upon implementation-specific or other considerations, price structures can be specific to the facility and/or characteristics of a product to be flash retailed at the facility. For example, if the facility is located in an area that receives a lot of customer foot traffic, then the price structure can be higher for the facility. Further depending upon implementation-specific or other considerations, a price structure can be specific to services the product developer wants for selling their products at the facility through flash retailing. For example, if a product developer wants their product to be demonstrated, then the price structure can be increased over a price structure for simply displaying the product at the facility.

The flowchart 600 continues to module 612, where a payment for the selected facility is received from the product developer. An applicable engine for communicating with a product developer for purposes of flash retailing, such as the product developer system management engines described in this paper, can received payment for the selected facility from the product developer. In various implementations, payment can be received based on a selected price structure of the one or more identified price structures. For example, if the product developer agrees to a price structure that includes demonstration of the product at the facility, then payment in accordance with the price structure can be received. After receiving payment, the right to have the product flash retailed at the facility is secured for the product developer and the facility can be subsequently configured according to the selected pre-defined facility configurations.

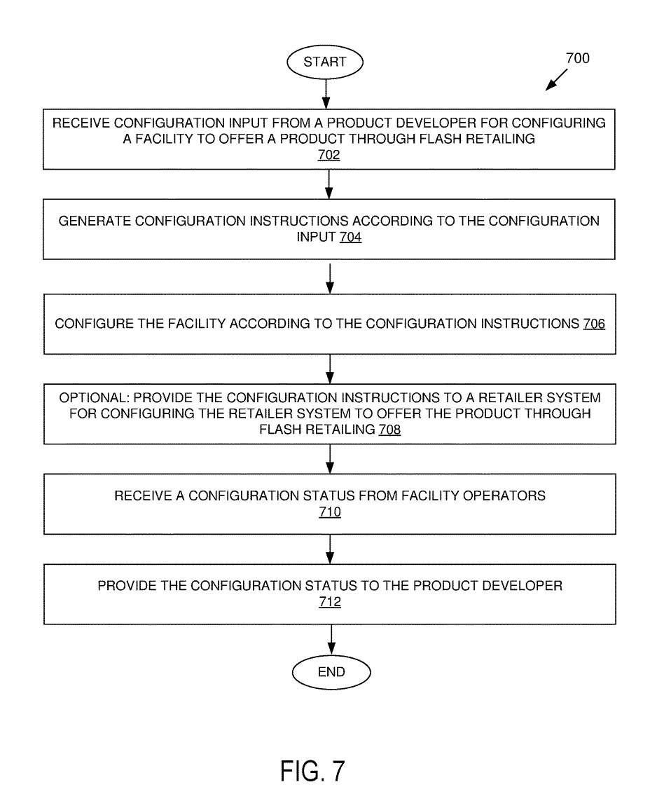

FIG. 7 depicts a flowchart 700 of an example of a method for configuring a facility for offering a product through flash retailing. The flowchart 700 begins at module 702, where configuration input is received from a product developer for configuring a facility to offer a product through flash retailing. An applicable engine for communicating with a product developer for purposes of flash retailing, such as the product developer system management engines described in this paper, can receive configuration input from a product developer. Depending upon implementation-specific or other considerations, configuration input can include retail configuration input used in configuring a retailer system to offer a product through flash retailing. Further depending upon implementation-specific or other considerations, received configuration input can include a customized configuration or a pre-defined configuration. For example, received configuration input can include a customized configuration created by customizing a pre-defined configuration of a facility.

The flowchart 700 continues to module 704, where configuration instructions are generated according to the configuration input. Configuration instructions can be generated by an applicable engine for managing a facility or a retailer system for purposes of flash retailing, such as the flash retailing facility management engines and the flash retailing retailer system management engines described in this paper. Depending upon implementation-specific or other considerations, configuration instructions can be generated using, at least in part, product analytics data. For example, if product analytics data indicates sales of the product increase when the product is placed in front of a facility, then configuration instructions can be generated instructing to display the product in the front of the facility.

The flowchart 700 continues to module 706, where facility is configured according to the configuration instructions. An applicable engine for managing a facility for purposes of flash retailing, such as the flash retailing facility management engines described in this paper, can configure the facility according to the configuration instructions. In various implementations, the facility can be configured by providing the configuration instructions to facility operators at the facility, who can configure the facility according to the configuration instructions. Configuration instructions can be sent to facility operator devices, where facility operators can view the configuration instructions and subsequently configure the facility. Depending upon implementation-specific or other considerations, facility display systems at the facility can be controlled according to the configuration instructions. For example, if configuration instructions specify to display a specific advertisement, then a display system at the facility can be controlled to display the specific advertisement.

The flowchart 700 optionally continues to module 708, where the configuration instructions are provided to a retailer system for configuring the retailer system to offer the product through flash retailing. An applicable engine for managing a retailer system for purposes of flash retailing, such as the flash retailing retailer system management engines described in this paper, can provide the configuration instructions to a retailer system. In various implementations, the retailer system can configure an online store according to the configuration instructions to offer the product through the online store.

The flowchart 700 continues to module 710, where a configuration status is received from the facility operators. An applicable engine for managing a facility for purposes of flash retailing, such as the flash retailing facility management engines described in this paper, can receive a configuration status from the facility operators. A configuration status can indicate a stage in configuring a facility according to the configuration instructions. The facility operators can send a configuration status through facility operator devices.

The flowchart 700 continues to module 712, where the configuration status is provided to the product developer. An applicable engine for communicating with a product developer for purposes of flash retailing, such as the product developer system management engines described in this paper, can provide the configuration status to the product developer. Depending upon implementation-specific or other considerations, the product status can be provided to the product developer through a native application executing at a device of the product developer, or a web-based application accessed through a web browser executing at the device of the product developer.

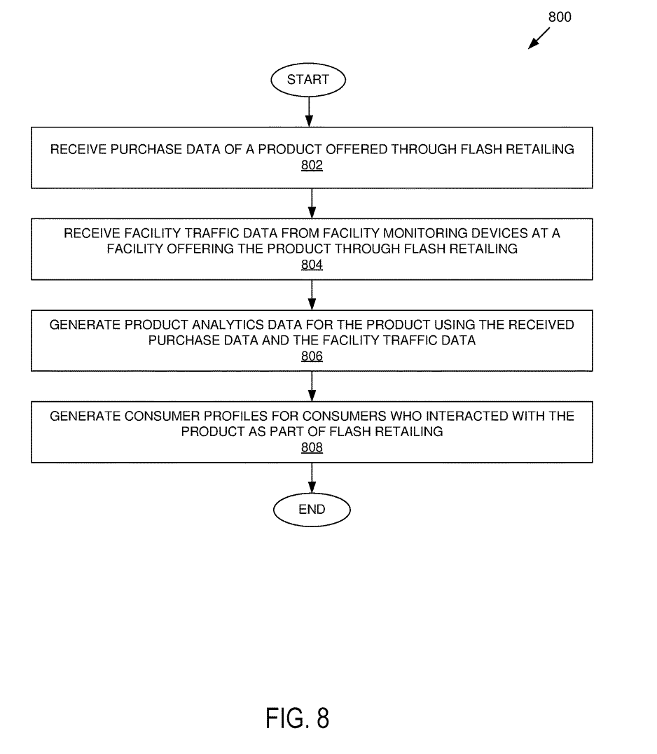

FIG. 8 depicts a flowchart 800 of an example of a method for maintaining data used in managing flash retailing of a product. The flowchart begins at module 802, where purchase data of a product offered through flash retailing. Purchase data can be received by an applicable engine for managing a retailer system or onsite equipment at a facility for purposes of flash retailing, such as the flash retailing retailer system management engines and the facility onsite equipment engines described in this paper. Depending upon implementation-specific or other considerations, purchase data can be received for a purchase of a product offered at a facility as part of flash retailing. For example, purchase data can be received to indicate a customer purchased a product at a facility offering the product through flash retailing from a facility operator device used to facilitate the transaction for the product at the facility. Further depending upon implementation-specific or other considerations, purchase data can be received for purchase of a product through a retailer system. For example, purchase data can be received from an online store of a retailer system through which a consumer purchased a product offered through the online store a part of flash retailing.

The flowchart 800 continues to module 804, where facility traffic data is received form facility monitoring devices at a facility offering the product through flash retailing. An applicable engine for receiving data from onsite equipment at a facility offering products through flash retailing, such as the facility onsite equipment management engines described in this paper, can receive facility traffic data from facility monitoring devices at a facility offering the product through flash retailing. Facility traffic data can be received from cameras positioned at a facility offering flash retailing or other applicable devices configured to track consumer movements at a facility offering flash retailing.

The flowchart 800 continues to module 806, where product analytics data is generated for the product using the received purchase data and the facility traffic data. An applicable engine for managing data used in providing flash retailing, such as the flash retailing data management engines described in this paper, can generate product analytics data for the product using the received purchase data and the facility traffic data. Depending upon implementation-specific or other considerations, product analytics data can be generated by correlating the received purchase data and the facility traffic data. In various implementations, generated product analytics data can be distributed to a product developer and/or a retailer system.

The flowchart 800 continues to module 808, where consumer profiles are generated for consumers who interact with the product as part of flash retailing. An applicable engine for managing data used in providing flash retailing, such as the flash retailing data management engines described in this paper, can generate consumer profiles for consumers who interact with the product as part of flash retailing. Depending upon implementation-specific or other considerations, consumer profiles can be generated from facility traffic data received from a facility offering products as part of flash retailing. Further depending upon implementation-specific or other considerations, consumer profiles can be generated from data received from onsite equipment at a facility offering products as part of flash retailing. Depending upon implementation-specific or other considerations, consumer profiles can be generated from data received from retailer systems offering products as part of flash retailing. Consumer profiles can be provided to product developers offering products through flash retailing.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving, from a product developer, a rent request to obtain a right to occupy a facility for purposes of selling a product using the facility according to a flash retailing model;
receiving facility configuration input from the product developer for configuring the facility to sell the product through the flash retailing model;
reserving, for the product developer, the right to occupy the facility to sell the product through the flash retailing model;
generating configuration instructions based on the facility configuration input;
sending the configuration instructions to facility operators, the facility operators using the configuration instructions to configure the facility for selling the product according to the flash retailing model.

2. The method of claim 1, further comprising:
receiving facility traffic data from facility monitoring devices at the facility;
generating product analytics data for selling of the product at the facility according to the flash retailing model using the facility traffic data.

3. The method of claim 1, further comprising:
receiving facility traffic data from facility monitoring devices at the facility;
receiving purchase data from facility operator devices used by the facility operators to complete transactions for product sold at the facility;
correlating the facility traffic data and the purchase data;
generating product analytics data for selling of the product at the facility according to the flash retailing model based on a correlation of the facility data and the purchase data.

4. The method of claim 1, further comprising:
generating product analytics data for selling of the product at the facility according to the flash retailing model, the product analytics data including consumer profiles of consumers who interacted with the product at the facility, the consumer profiles including market segments into which the consumers are segmented according to market segmentation variables;
providing the product analytics data to the product developer for use by the product developer to determine specific market segments to target in selling the product.

5. The method of claim 1, further comprising:
identifying pre-defined configurations for the facility for selling products according to the flash retailing model;
providing the pre-defined configurations to the product developer, the pre-defined configurations used by the product developer to generate the retail configuration input.

6. The method of claim 1, wherein the retail configuration input includes a custom configuration of a pre-defined configuration of the facility.

7. The method of claim 1, further comprising:
receiving retail configuration input for a retailer system to sell the product to sell the product according to the flash retailing model;
generating retail configuration instructions based on the retail configuration input;
sending the retail configuration instructions to the retailer system, the retailer system configuring using the retail configuration instructions to configure itself for selling the product according to the flash retailing model.

8. The method of claim 1, wherein the configuration instructions are generated from the facility configuration input and product analytics data of products sold at the facility according to the flash retailing model.

9. The method of claim 1, further comprising:
managing facility display systems at the facility using product information for the product provided by the manufacturer.

10. The method of claim 1, wherein the rent request identifies a region in which the product developer wants to sell the product according to the flash retailing model, the method further comprising:
identifying a plurality of facilities, including the facility, for selling products according to the flash retailing model in the region;
providing a list of the plurality of facilities to the product developer, the product developer using the list of the plurality of facilities to select the facility for selling the product according to the flash retailing model;
identifying price structures for securing the right to occupy the facility for selling the product according to the flash retailing model;
providing the price structures to the product developer;
receiving payment according to a price structure to sell the product at the facility according to the flash retailing model, the price structure selected by the produce developer from the price structures;
reserving, for the product developer, the right to occupy the facility to sell the product according to the flash retailing model in response to receipt of the payment.

11. A system comprising:
a product developer system management engine configured to:
receive, from a product developer, a rent request to obtain a right to occupy a facility for purposes of selling a product using the facility according to a flash retailing model;
receive facility configuration input from the product developer for configuring the facility to sell the product through the flash retailing model;
a facility rental engine configured to reserve, for the product developer, the right to occupy the facility to sell the product through the flash retailing model;
a flash retailing facility management engine configured to:
generate configuration instructions based on the facility configuration input;
send the configuration instructions to facility operators, the facility operators using the configuration instructions to configure the facility for selling the product according to the flash retailing model.

12. The system of claim 11, further comprising:
a facility onsite equipment management engine configured to receive facility traffic data from facility monitoring devices at the facility;
a flash retailing data management engine configured to generate product analytics data for selling of the product at the facility according to the flash retailing model using the facility traffic data.

13. The system of claim 11, further comprising:
a facility onsite equipment management engine configured to:
receive facility traffic data from facility monitoring devices at the facility;
receive purchase data from facility operator devices used by the facility operators to complete transactions for product sold at the facility;
a flash retailing data management engine configured to:
correlate the facility traffic data and the purchase data;
generate product analytics data for selling of the product at the facility according to the flash retailing model based on a correlation of the facility data and the purchase data.

14. The system of claim 11, further comprising:
a flash retailing data management engine configured to generate product analytics data for selling of the product at the facility according to the flash retailing model, the product analytics data including consumer profiles of consumers who interacted with the product at the facility, the consumer profiles including market segments into which the consumers are segmented according to market segmentation variables;
the product developer system management engine further configured to provide the product analytics data to the product developer for use by the product developer to determine specific market segments to target in selling the product.

15. The system of claim 11, wherein the facility rental engine is further configured to identify pre-defined configurations for the facility for selling products according to the flash retailing model and the product developer system management engine is further configured to provide the pre-defined configurations to the product developer, the pre-defined configurations used by the product developer to generate the retail configuration input.

16. The system of claim 11, wherein the retail configuration input includes a custom configuration of a pre-defined configuration of the facility.

17. The system of claim 11, wherein the product developer system management engine is further configured to receive retail configuration input for a retailer system to sell the product to sell the product according to the flash retailing model, the system further comprising a flash retailing retailer system management engine configured to:
generate retail configuration instructions based on the retail configuration input;
send the retail configuration instructions to the retailer system, the retailer system configuring using the retail configuration instructions to configure itself for selling the product according to the flash retailing model.

18. The system of claim 11, wherein the configuration instructions are generated from the facility configuration input and product analytics data of products sold at the facility according to the flash retailing model.

19. The system of claim 11, wherein the rent request identifies a region in which the product developer wants to sell the product according to the flash retailing model, the system further comprising:
the facility rental engine further configured to:
identify a plurality of facilities, including the facility, for selling products according to the flash retailing model in the region;
identify price structures for securing the right to occupy the facility for selling the product according to the flash retailing model;
the product developer system management engine further configured to:
provide a list of the plurality of facilities to the product developer, the product developer using the list of the plurality of facilities to select the facility for selling the product according to the flash retailing model;
provide the price structures to the product developer;
receive payment according to a price structure to sell the product at the facility according to the flash retailing model, the price structure selected by the produce developer from the price structures;
in response to receipt of the payment, the facility rental engine further configured to reserve, for the product developer, the right to occupy the facility to sell the product according to the flash retailing model.

20. A system comprising:
means for receiving, from a product developer, a rent request to obtain a right to occupy a facility for purposes of selling a product using the facility according to a flash retailing model;
means for receiving facility configuration input from the product developer for configuring the facility to sell the product through the flash retailing model;
means for reserving, for the product developer, the right to occupy the facility to sell the product through the flash retailing model;
means for generating configuration instructions based on the facility configuration input;
means for sending the configuration instructions to facility operators, the facility operators using the configuration instructions to configure the facility for selling the product according to the flash retailing model.
